(19) United States
(12) Patent Application Publication
(10) Pub. No.: US 2019/0221916 A1
(43) Pub. Date: Jul. 18, 2019

(54) Clip-on 2.4 GHz Wi-Fi Range-Extending Coupled-Resonator Antenna for Laptop Computers and Mobile Devices.

(71) Applicant: James Davis Adams, Willamina, OR (US)

(72) Inventor: James Davis Adams, Willamina, OR (US)

(21) Appl. No.: 15/873,358

(22) Filed: Jan. 17, 2018

(51) Int. Cl. H01Q 1/22; H01Q 9/22; H01Q 1/24

(52) U.S. Cl. CPC H01Q 1/2258; H01Q 1/245; H01Q 1/2291; H01Q 9/22

(57) ABSTRACT

A lightweight 2.4 GHZ antenna designed to be clipped onto a laptop computer or mobile device to extend the range of operation. The device consists of a tubular plastic frame upon which wire loops and a reflector are mounted and aimed toward the intended source of Wi-Fi signal. Radio-Frequency energy is transferred bidirectionally from the antenna to embedded antennas in the laptop computer or mobile device so no hardwired connection is necessary. Operation requires no power. The device can be scaled to 5 GHz Wi-Fi and other frequency bands including cellular.

### BACKGROUND OF THE INVENTION

The coupled-resonator Wi-Fi range-extending antenna is a communications device intended to conveniently improve signal strength between computing devices and a Wi-Fi router or hotspot. It does so without external power and without a hardwired connection. Existing techniques of prior art rely on electronic amplification, bulky antennas and hardwired connections to the laptop computer to increase range, all of which contribute to the complexity and difficulty in setting up a Wi-Fi session.

The coupled-resonator Wi-Fi range-extending antenna grew out of years of experimentation with Numerical Electromagnetics Code antenna simulations. My first prototype worked well but was bulkier and tedious to adjust the phasing properly. My final prototype solved these issues and evolved into a highly portable and marketable invention that increases gain on the receive and transmit links of 2.4 GHz Wi-Fi. Simulations I've performed with 4NEC2 indicate the invention is scaleable for other frequency bands, including cellular and 5 GHz Wi-Fi.

### BRIEF SUMMARY OF THE INVENTION

The coupled-resonator Wi-Fi range-extending antenna extends the useful range of operation without a hardwired connection to the computer or mobile device. The Radio-Frequency energy is transferred bidirectionally through two elements, one being the embedded antenna in the computing device, the other being the driven element in the coupled-resonator Wi-Fi range-extending antenna. The driven element is the focal point of RF energy entering and leaving the antenna through reciprocity, and normally is connected to a transmission line. The antenna is clipped onto the laptop display along the bezel over where the embedded antenna is mounted. The mounting location is dictated by a 2 wavelength spatial diversity in laptops, and in mobile devices a closer spacing is typically used. A block of pliant material is used to hold the antenna in place on the edge of the computing device. Precise aiming of the Wi-Fi beam is achieved by sighting through the hollow body of the antenna. Field testing with various makes and models of laptop computers proved the concept was viable. The concept is easily adapted to mobile devices which generally share a similar low-profile case with internal embedded antennas. In this implementation the body of the antenna is perpendicular to the plane of the laptop display, or perpendicular to the bezel of the mobile device when in use. The body of the structure in the drawings is constructed of polyvinyl chloride tubing.

### BRIEF DESCRIPTION OF DRAWINGS

Three views are shown.

FIG. 1 is a side view.

FIG. 2 is a top view.

FIG. 3 is a front view head-on.

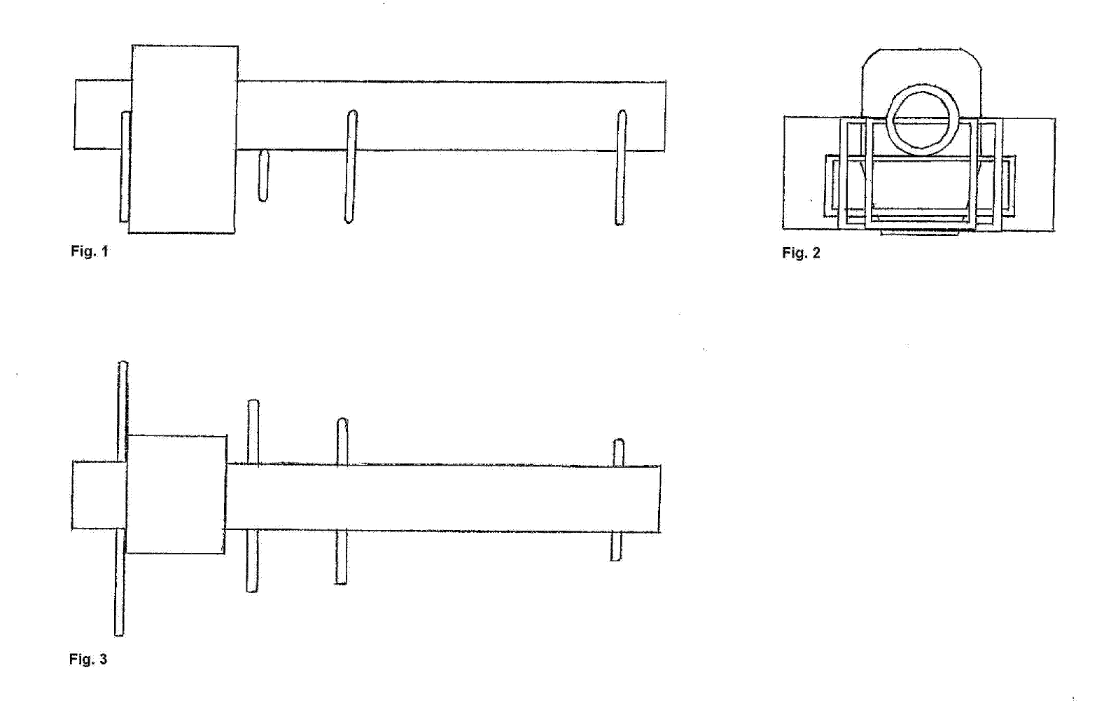

### DETAILED DESCRIPTION OF THE INVENTION

The coupled-resonator range-extending antenna increases the gain of Wi-Fi signals by gathering and shaping the incoming and outgoing beams of Wi-Fi Radio Frequency energy in a particular direction. The Radio-Frequency energy passes through two loop directors and a driven loop element that shape the RF into a rectangular form similar to that of the embedded antennas in the laptop computer or mobile device. The RF is coupled bidirectionally across the plastic bezel through two elements, the driven antenna element and the embedded antenna of the computing device. These elements share two fundamental properties, that of resonance centered on 2.44 GHz, and a rectangular shape of approximately 0.4 in.×1¾ in. With these parameters matched, the two elements tend to resonate in tandem. Simulations performed with 4NEC2 indicate a power gain of 15 dBi.

A wavelength at 2.44 GHz is close to 5 in. The 2 wavelength spatial diversity used in laptops allows for approximately 10 inches spacing between the two antennas. For a laptop display that is 12 inches wide, the embedded antennas can usually be found 1 inch in from the upper corners of the display bezel. In mobile devices a closer spacing of ½ wavelength is typically used. Regardless of the exact method of mobile device construction, the location of the embedded antennas can be found by experimentation or by referring to product literature.

A block of closed-cell plastic foam material that is transparent to RF creates a slot to hold the antenna in place so the driven element is laying flat against the top of the laptop display. The beam of the antenna is perpendicular to the plane of the laptop display, so the strongest Wi-Fi energy is received from forward or rearward, depending on which way the antenna is placed. The antenna frame is composed of ⅝ inch polyvinyl chloride tubing, but could also be constructed of injection-molded plastic to reinforce the mounting of the driven element on the underside of the PVC tubing. Many materials with the proper RF properties could be used as long as the wire spacing and loop size are correct.

The invention is constructed by first cutting plastic tubing material such as PVC to a length of 5½ inches. Come back ½ inch from one end and drill the first two side-holes with a diameter of 0.1 inch for #10 wire or 0.08 inch for #12. Come back another 2 9/16 inches from the first two holes and drill the next two side-holes the same diameter. Next drill the last set of side-holes ½ inch in from the other end of the PVC tubing. All the antenna elements are made from either #12 or #10 copper wire for best performance. The first director is made from 4 inches of wire. Insert the 4 inches of wire through the first two side-holes and bend it in a square with 1 inch sides. Shape the corners as sharply as possible but not so sharply that it stresses the copper. Solder the ends together in the middle of the bottom side to make a complete square.

Make the second director from 5 inches of wire, inserting it through the second set of holes and bending it into a rectangle that is 1½ inches wide and 1 inch high. Solder the ends together to form a complete rectangle. Make the driven element from 4.3 inches of wire. Form it into a rectangular loop 1¾ inches wide and 0.4 inches high (point 4 inches). Solder the ends together and allow to cool. Glue it on the bottom of the PVC tubing oriented horizontally exactly ⅞ inch back from the second director using cyanoacrylate and allow to dry. Next slip on the plastic foam piece around the PVC tubing behind the driven element.

Make the reflector out of 7 inches of wire. Insert it through the last set of side-holes and bend it into a rectangle that is 2½ inches wide and 1 inch high. In this position the reflector is 1.2 inches (a quarter wavelength) behind the driven element. Solder a 2½ inch×1 inch rectangle of copper or brass foil onto the wire framework to finish the reflector. Slide the plastic foam material rearward against the reflector and tack it in place with cyanoacrylate. A slot of approximately ¼ inch width should be formed behind the driven antenna element to accommodate the laptop computer or mobile device. Lastly, position and tack the loops in place with a drop of cyanoacrylate where the wires pass through the holes in the tubing, and allow to dry. Assembly of the invention is complete.

1) An apparatus for extending the range of 2.4 GHz Wi-Fi signals, said apparatus comprising a high-gain, beam-shaping antenna with a driven element designed to transfer Radio-Frequency energy bidirectionally through the plastic case of a laptop computer or mobile device to their internal embedded antennas.

2) Said apparatus uses a pad of pliant material that is transparent to RF to hold the apparatus in place on laptop displays or mobile devices of varying widths to provide easy installation and removal.

3) Said apparatus is scaleable to 5 GHz Wi-Fi by shortening the elements and spacing, and adaptable to other frequency bands including cellular where the utility and convenience of the coupled-resonator connection to internal antennas is desired.
